(19) United States
(12) Patent Application Publication
(10) Pub. No.: US 2018/0055010 A1
(43) Pub. Date: Mar. 1, 2018

(54) Dog Training System

(71) Applicant: Ben Oostdik, Kaukauna, WI (US)

(72) Inventor: Ben Oostdik, Kaukauna, WI (US)

(21) Appl. No.: 15/252,710

(22) Filed: Aug. 31, 2016

(51) Int. Cl. A01K 15/02; A01K 27/00

(52) U.S. Cl. CPC A01K 15/021; A01K 27/003; A01K 27/001

(57) ABSTRACT

A dog training system includes a collar that may be worn on an animal. A plurality of vibration units is provided. Each of the vibration units is coupled to the collar. Thus, each of the vibration units selectively vibrationally engages the animal when the vibration units are turned on. A leash is coupled to the vibration units and the leash may be gripped. The leash turns on each of the vibration units when the dog pulls on the leash. Thus, each of the vibration units trains the dog to resist pulling on the leash.

### BACKGROUND OF THE DISCLOSURE

### Field of the Disclosure

The disclosure relates to training devices and more particularly pertains to a new training device for training a dog to resist tugging on a leash.

### SUMMARY OF THE DISCLOSURE

An embodiment of the disclosure meets the needs presented above by generally comprising a collar that may be worn on an animal. A plurality of vibration units is provided. Each of the vibration units is coupled to the collar. Thus, each of the vibration units selectively vibrationally engages the animal when the vibration units are turned on. A leash is coupled to the vibration units and the leash may be gripped. The leash turns on each of the vibration units when the dog pulls on the leash. Thus, each of the vibration units trains the dog to resist pulling on the leash.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a dog training system according to an embodiment of the disclosure.

FIG. 2 is a front view of an embodiment of the disclosure.

FIG. 3 is a top view of an embodiment of the disclosure.

FIG. 4 is a cross sectional view taken along line 4-4 of FIG. 2 of a switch of an embodiment of the disclosure in an off position.

FIG. 5 is a cross sectional view taken along line 4-4 of FIG. 2 a switch of an embodiment of the disclosure in an on position.

### DESCRIPTION OF THE PREFERRED EMBODIMENT

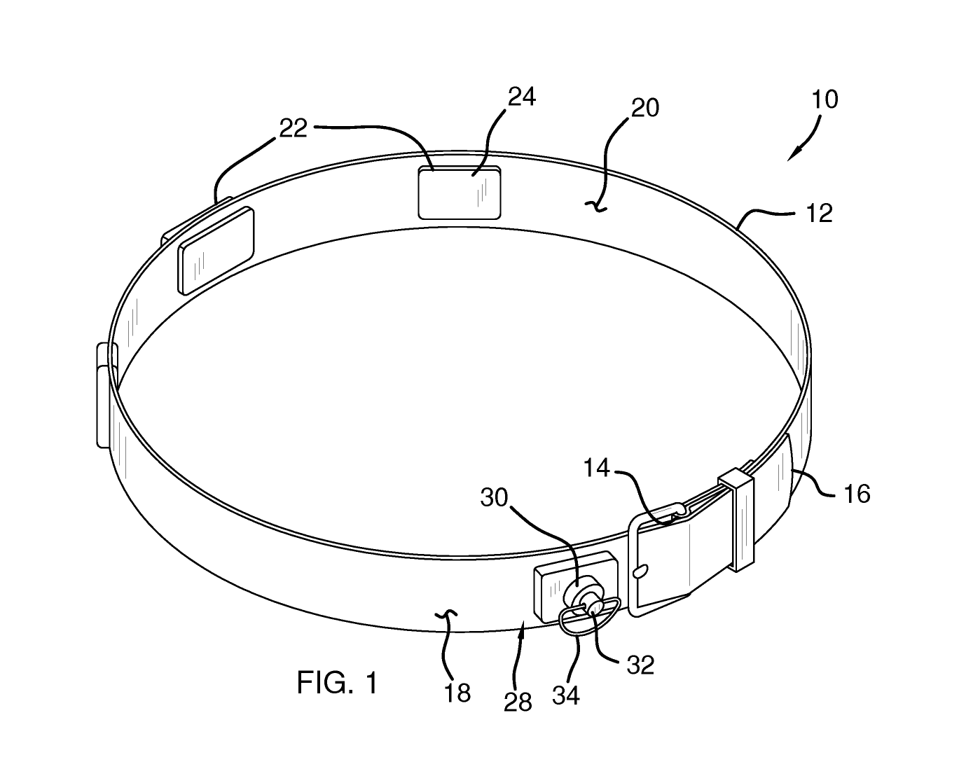

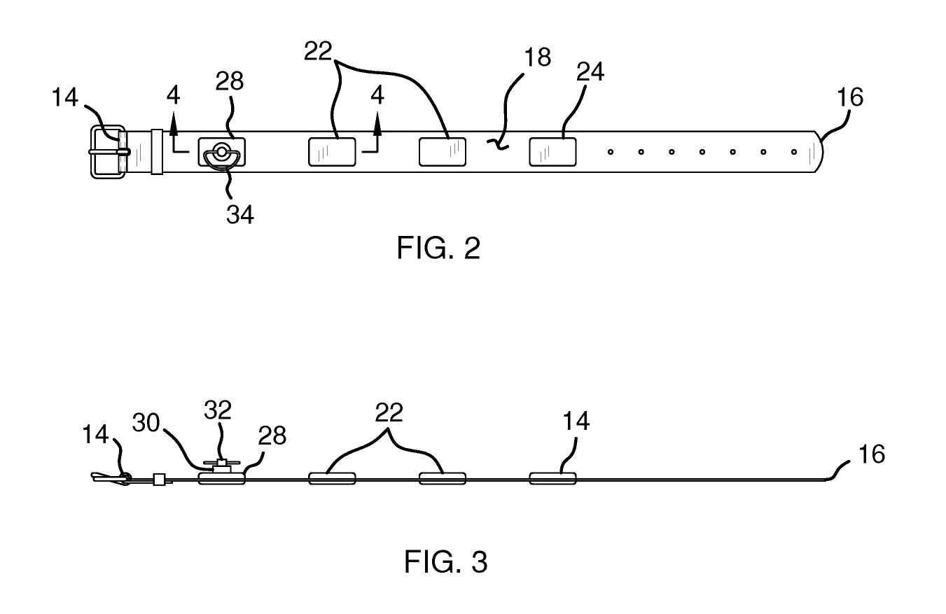

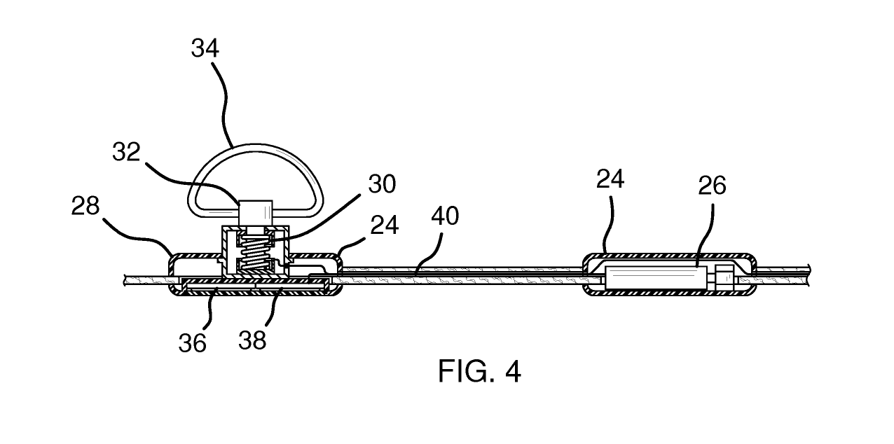

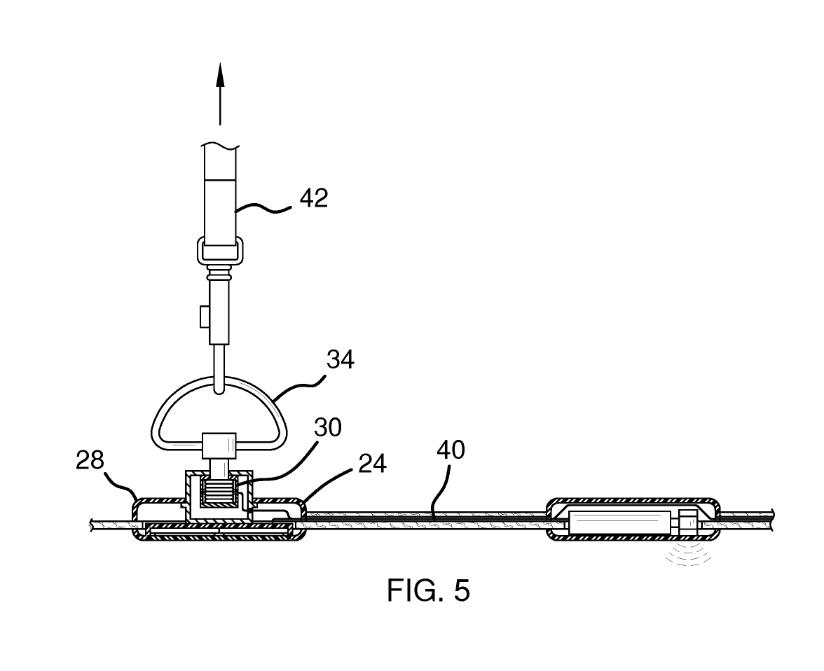

With reference now to the drawings, and in particular to FIGS. 1 through 5 thereof, a new training device embodying the principles and concepts of an embodiment of the disclosure and generally designated by the reference numeral 10 will be described.

As best illustrated in FIGS. 1 through 5, the dog training system 10 generally comprises a collar 12 that may be worn on an animal. The animal may be dog or other domesticated animal. The collar 12 has a first end 14, a second end 16, a first surface 18 and a second surface 20. The first end 14 is matable to the second end 16. Thus, the collar 12 is retained on the animal.

A plurality of vibration units 22 is provided. Each of the vibration units 22 is coupled to the collar 12. Thus, each of the vibration units 22 selectively vibrationally engages the animal when the vibration units 22 are turned on. The vibration units 22 are spaced apart from each other and are distributed between the first end 14 and the second end 16 of the collar 12.

Each of the vibration units 22 comprises a housing 24. The housing 24 is coupled to the collar 12. The housing 24 extends through the first surface 18 and the second surface 20 of the collar 12. Thus, the housing 24 frictionally engages the animal when the collar 12 is worn.

A vibrator 26 is provided. The vibrator 26 is positioned within the housing 24. The vibrator 26 repeatedly engages the housing 24 when the vibrator 26 is turned on. Thus, the vibrator 26 selectively vibrates the housing 24. The vibrator 26 may comprise an electric motor and a cam being rotatably coupled to the motor. The cam may repeatedly engage the housing 24 when the motor is turned on.

The plurality of vibration units 22 includes a master vibration unit 28. Each of the vibration units 22 is electrically coupled to the master vibration unit 28. The master vibration unit 28 includes a switch 30. The switch 30 is movably coupled to the housing 24 corresponding to the master vibration unit 28. The switch 30 may be manipulated.

The switch 30 is electrically coupled to the vibrator 26 corresponding to each of the vibration units 22 and the master vibration unit 28. The switch 30 turns the vibrator 26 corresponding to each of the vibration units 22 and the master vibration unit 28 on when the switch 30 is manipulated. The switch 30 may include a pole 32 that extends outwardly from the housing 24 corresponding to the master vibration unit 28. The switch 30 may be biased into an off position. The switch 30 may be urged into the on position when the pole 32 is pulled outwardly from the housing 24 corresponding to the master vibration unit 28.

A ring 34 is provided. The ring 34 coupled to the switch 30 such that the ring 34 is positioned outside of the housing 24 corresponding to the master vibration unit 28. The ring 34 may be positioned on the pole 32. The ring 34 may be a D-ring or the like.

A power supply 36 is provided. The power supply 36 is positioned within the housing 24 corresponding to the master vibration unit 28. The power supply 36 is electrically coupled to the switch 30. The power supply 36 comprises at least one battery 38. A conductor 40 may be positioned within the collar 12. The conductor 40 may electrically coupled between each of the vibration units 22 and the master vibration unit 28.

A leash 42 is provided. The leash 42 is selectively coupled to the ring 34. Additionally, the leash 42 is gripped by a user. The leash 42 manipulates the switch 30 when the dog pulls on the leash 42. Thus, each of the vibration units 22 is turned on to train the dog to resist pulling on the leash 42. The leash 42 may be a dog leash 42 or the like.

In use, the collar 12 is worn on the animal. The leash 42 is coupled to the ring 34 and the leash 42 is gripped when the animal is walked. The switch 30 is manipulated into the on position when the animal pulls on the leash 42. Thus, each of the vibration units 22 is turned on. Each of the vibration units 22 facilitates tactile feedback to the animal when the animal pulls on the leash 42. Thus, each of the vibration units 22 facilitates negative reinforcement with respect to pulling on the leash 42.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dog training system being configured to teach a dog to resist tugging on a leash, said system comprising:
a collar being configured to be worn on an animal;
a plurality of vibration units, each of said vibration units being coupled to said collar wherein each of said vibration units is configured to selectively vibrationally engage the animal when said vibration units are turned on; and
a leash being coupled to said vibration units, said leash being configured to be gripped, said leash turning on each of said vibration units when the dog pulls on said leash wherein each of said vibration units is configured to train the dog to resist pulling on said leash.

2. The system according to claim 1, wherein:
said collar has a first end, a second end, a first surface and a second surface, said first end being matable to said second end wherein said collar is configured to be retained on the animal; and
said vibration units being spaced apart from each other and being distributed between said first end and said second end of said collar.

3. The system according to claim 1, wherein:
said collar has a first surface and a second surface; and
each of said vibration units comprises a housing being coupled to said collar, said housing extending through said first surface and said second surface of said collar wherein said housing is configured to frictionally engage the animal when said collar is worn.

4. The system according to claim 3, further comprising a vibrator being positioned within said housing, said vibrator repeatedly engaging said housing when said vibrator is turned on such that said vibrator selectively vibrates said housing.

5. The system according to claim 1, wherein said plurality of vibration units includes a master vibration unit, each of said vibration units being electrically coupled to said master vibration unit.

6. The system according to claim 5, wherein:
said master vibration unit includes a housing and a vibrator; and
said master vibration unit includes a switch being movably coupled to said housing corresponding to said master vibration unit wherein said switch is configured to be manipulated, said switch being electrically coupled to said vibrator corresponding to each of said vibration units and said master vibration unit, said switch turning said vibrator corresponding to each of said vibration units and said master vibration unit on when said switch is manipulated.

7. The system according to claim 6, further comprising a ring being coupled to said switch such that said ring is positioned outside of said housing corresponding to said master vibration unit.

8. The system according to claim 6, further comprising a power supply being positioned within said housing corresponding to said master vibration unit, said power supply being electrically coupled to said switch, said power supply comprising at least one battery.

9. A dog training system being configured to teach a dog to resist tugging on a leash, said system comprising:
a collar being configured to be worn on an animal, said collar having a first end, a second end, a first surface and a second surface, said first end being matable to said second end wherein said collar is configured to be retained on the animal;
a plurality of vibration units, each of said vibration units being coupled to said collar wherein each of said vibration units is configured to selectively vibrationally engage the animal when said vibration units are turned on, said vibration units being spaced apart from each other and being distributed between said first end and said second end of said collar, each of said vibration units comprising:
a housing being coupled to said collar, said housing extending through said first surface and said second surface of said collar wherein said housing is configured to frictionally engage the animal when said collar is worn, and
a vibrator being positioned within said housing, said vibrator repeatedly engaging said housing when said vibrator is turned on such that said vibrator selectively vibrates said housing;
said plurality of vibration units including a master vibration unit, each of said vibration units being electrically coupled to said master vibration unit, said master vibration unit comprising:
a switch being movably coupled to said housing corresponding to said master vibration unit wherein said switch is configured to be manipulated, said switch being electrically coupled to said vibrator corresponding to each of said vibration units and said master vibration unit, said switch turning said vibrator corresponding to each of said vibration units and said master vibration unit on when said switch is manipulated,
a ring being coupled to said switch such that said ring is positioned outside of said housing corresponding to said master vibration unit,
a power supply being positioned within said housing corresponding to said master vibration unit, said power supply being electrically coupled to said switch, said power supply comprising at least one battery; and
a leash being coupled to said ring, said leash being configured to be gripped, said leash manipulating said switch when the dog pulls on said leash such that each of said vibration units is turned on wherein each of said vibration units is configured to train the dog to resist pulling on said leash.
